(19) United States
(12) Patent Application Publication
(10) Pub. No.: US 2008/0253544 A1
(43) Pub. Date: Oct. 16, 2008

(54) Automatically aggregated probabilistic personal contacts

(75) Inventors: Robert Ian Brown, Kirkland, WA (US); Piyush Dogra, Redmond, WA (US); Xuedong Huang, Bellevue, WA (US); Abhiram G. Khune, Sammamish, WA (US); Kuansan Wang, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/786,524

(22) Filed: Apr. 12, 2007

(51) Int. Cl. H04M 3/42

(52) U.S. Cl. 379/201.12

(57) ABSTRACT

Described is a technology by which a user's telephone-related data is aggregated from various sources for use in assisting the user with making telephone calls. For example, call history data corresponding to a landline telephone, a mobile telephone and/or an office telephone of the user may be combined. Other sources include a landline telephone service, a mobile telephone service, an enterprise telephone system or server, a computing device, voice mail data, web page data, electronic message content, instant message content, a contacts list, and/or an information data store. The telephone-related data can be processed (e.g., based on frequency and calling patterns) to determine corresponding probability data to help determine a user's intent in locating a particular recipient to call. The user may access the telephone-related data via voice commands input at one of the user's telephones, or by receiving a visible list of at least part of the telephone-related data.

### BACKGROUND

Many telephone users maintain one or more lists of people whom they call. In general, this has been a manual task that is tedious to accomplish. Some contemporary telephones maintain a log/call history, but there is a limited number of calls maintained, typically corresponding to the most recent outgoing and incoming calls. For example, an arbitrary history window is typically specified by the manufacturer. As a result, a user is not able to find a call made in the last month, for example, as soon as there are enough calls made since that time to occupy the overall history window. Further, in some telephones, only the number is logged, not the name of the caller (or the name is unknown).

Moreover, many telephone users have a number of telephones, including a work telephone, home telephone and mobile telephone. Each of these may have its own call history data, whereby a user cannot use his or her work telephone's call history while at home, for example, or use his or her home telephone's call history while using his or her mobile telephone while away from home.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which telephone-related data for a user from a plurality of sources is aggregated and may then be used to assist the user with a subsequent telephone operation, such as making a telephone call. For example, aggregating the telephone-related data may combine call history data corresponding to a landline telephone, a mobile telephone and/or an office telephone of the user.

The telephone-related data may be processed based on frequency and call pattern data to establish which telephone number the user is likely trying to connect to in an outgoing call. The user may access the telephone-related data via voice commands input at one of the user's telephones, or by receiving a visible list of at least part of the telephone-related data. For example, the user may select a call recipient from among the telephone-related data by voice command or by selecting from the visible list. The call may then be automatically dialed.

In one example implementation, an aggregation service collects the telephone-related data corresponding to a user to maintain a call history for the user built at least in part by the aggregation service from the collected telephone-related data. The service provides an interface set containing at least one interface by which the user accesses the call history to assist in making a telephone call. For example, the interface can be a speech interface or by data signals.

The telephone-related data can be harvested from any number of sources, including a telephone gateway, a mobile telephone, a landline telephone service, a mobile telephone service, an enterprise telephone system or server, a computing device, voice mail data, web page data, electronic message content, instant message content, a contacts list, and/or an information data store. The telephone-related data can be processed to determine corresponding probability data that may be applied to determine a user's intent with respect to making a telephone call to a particular recipient. For example, if the probability is high enough that the user has intended a particular recipient, the call may be automatically placed to that recipient, otherwise the service can communicate (e.g., by speech or a list) likely candidates back to the recipient whereby the user can select the one that was intended.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative block diagram example of a general-purpose telephony environment including an aggregation service that collects telephone-related information for users from various sources.

FIG. 2 shows an illustrative block diagram example of an alternative general-purpose telephony environment including an aggregation service as an agent of a web service that collects telephone-related information for users from various sources.

FIG. 3 is a flow diagram representing example steps taken by an aggregation service to harvest the user-related information.

FIG. 4 is a flow diagram representing example steps taken by a user to access the aggregation service for purposes of making a telephone call.

FIG. 5 is a flow diagram representing example steps taken by a user to access the aggregation service via voice commands for purposes of making a telephone call.

FIG. 6 shows an illustrative example of a general-purpose network computing environment into which various aspects of the present invention may be incorporated.

### DETAILED DESCRIPTION

Various aspects of the technology described herein are generally directed towards aggregating a user's call history regardless of which telephone made or received a call, e.g., on the user's home telephone, work telephone and/or mobile telephone. Further, as will be understood, the call history may be presented as a set of aggregated contacts, in a more intelligent way for people to use.

In one example implementation, a web service is coupled to each of a plurality of user's telephones, and the web service can ordinarily identify the name associated with the number of an incoming or outgoing call on any of those phones. Telephone-related data including the number and typically the name are logged for subsequent access by the user, and may be processed (analyzed and/or organized) probabilistically. In this manner, it is possible for the user to easily find and connect to people by name, without needing to look up someone's phone number in order to talk to that person. In another alternative, an aggregation service is provided that acts in essentially the same way, but need not be coupled through the Internet as a web service. For example, an aggregation service may be provided by a mobile telephone service provider, by a landline telephone service provider, or even implemented on a personal computer or the like, or any combination thereof.

As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and telephony communication in general.

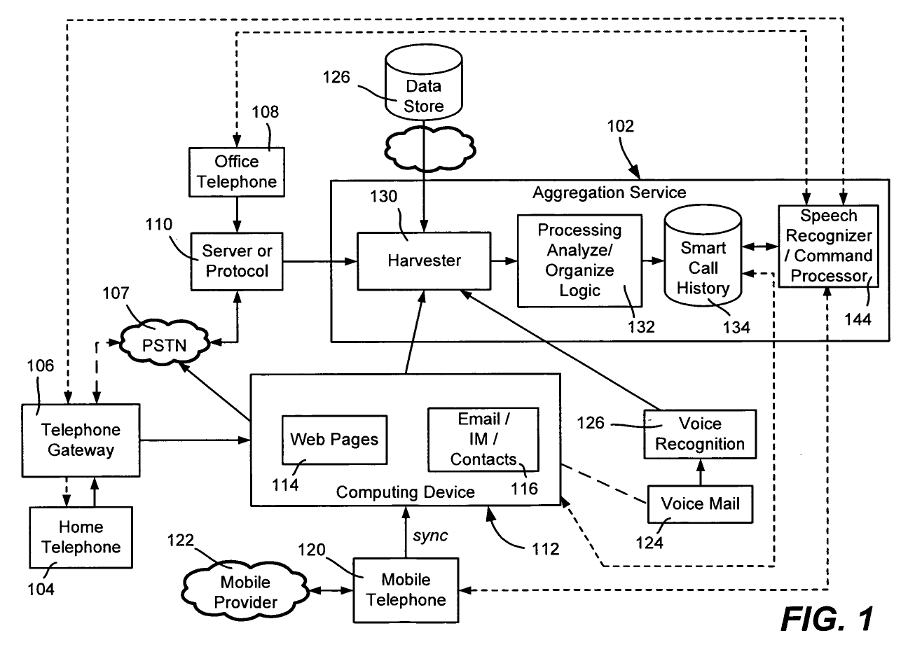

Turning to FIG. 1, there is shown an aggregation service 102 that aggregates a user's telephone history from multiple resources. Example resources include a home telephone 104/telephone gateway 106 (e.g., an analog telephone adapter for coupling digital telephones to the Public Switched Telephone Network or PSTN 107), and an office telephone 108/server or protocol 110. A computing device 112 such as a personal computer is another example resource, such as providing web page data of telephone numbers that appeared on a user's visited web pages 114, email and/or instant messaging (I/M) message data and/or contacts 116, and a mobile telephone 120 coupled to a mobile telephone service 122. The telephone gateway 106 and the mobile telephone 120 are exemplified in FIG. 1 as providing call history data (and possibly other user-specific information such as speed dial numbers) to the computing device 112. For example, if the telephone gateway 106 is an analog telephone adapter, the computing device 112 may already have the information; the mobile telephone 120 may provide its data via a synchronization operation with the computing device 112. Alternatively, the mobile telephone may provide its information to the aggregation service 102, e.g., via IP-based synchronization or by dialing a number and uploading its relevant data. The work server or protocol 110 may coupled directly to the aggregation service 102, or may have its data downloaded to an intermediary device, such as the computing device 112, for providing to the aggregation service 102.

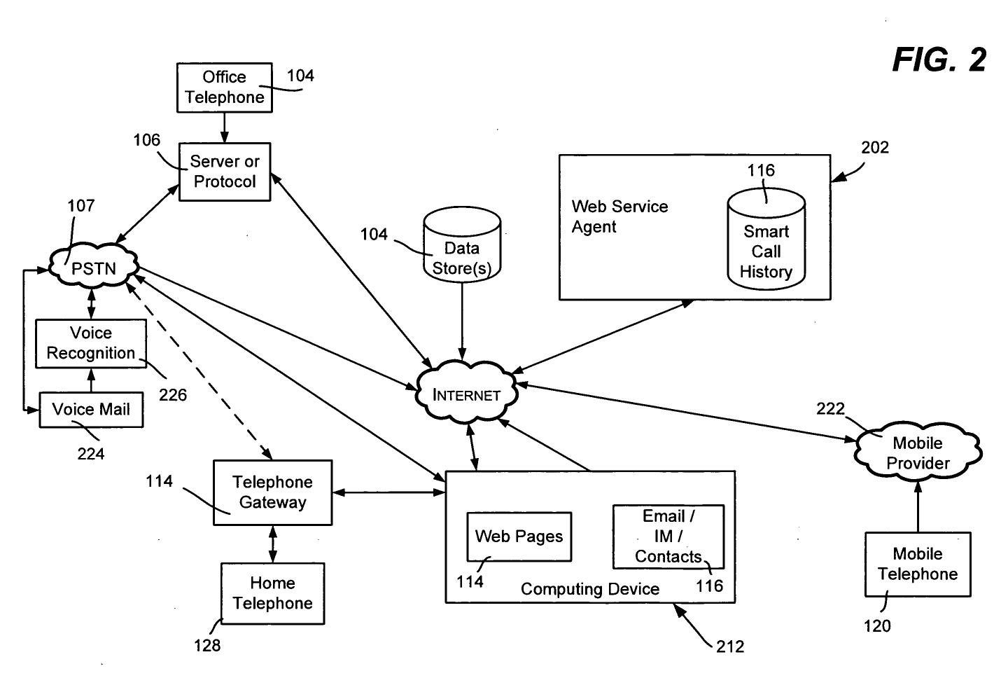

Still other example resources in FIG. 1 include voice mail 124, e.g., recognized as text via voice recognition software 126. The voice mail 124 may be closely associated with or incorporated into the computing device 112, or may be a voice messaging service provided by a landline telephone service or the like, (as described below with reference to FIG. 2). Voice-message-to-email is already available, and thus may be leveraged, e.g., to send an email to the aggregation service 102 for processing. A call can also be listed to as it is taking place via speech recognition/voiceprint matching to figure out who is calling if no other information about the source is available. Voiceprint matching can also be used with messages to guess at caller ID for providing to the user, and likewise for call screening, e.g., the user can pick up the telephone as a message is still being recorded when voiceprint matching provides a caller ID.

A data store (or stores) 126 such as available from one or more information services such as search services, yellow page services and so forth that can relate names, business categories, web pages, and/or addresses to telephone numbers is another exemplified resource. As can be readily appreciated, these resources are only examples, and for any given scenario there may be others that are not represented in FIG. 1, and/or there may less than those represented, e.g., a user's office telephone may be owned by a company that does not want to participate in aggregation.

In general, the called or received telephone numbers corresponding to multiple called places or incoming calls that may be of interest to the user are collected and tagged (mapped to that specific user) by a harvester component 130 of the aggregation service 102, and maintained in association with that particular user. For example, the call history on the home phone 104 (facilitated by the gateway 106/computing device 112), mobile telephone (when synchronized with the computing device 112), and office telephone 108 (e.g., collected from a Communications Server or via a specific protocol 110 for transferring the call history to the computing device 112 or otherwise) are collected by the harvester component 130 and mapped to the same user, such as via a service-unique identifier associated with that user and each user device.

Once collected, the data from the various sources are analyzed by analyze logic 132, including analysis such as based on each called number's frequency of being called, and its usage pattern. In addition to called and/or incoming telephone number data), the harvester component 130 may collect telephone numbers found in the users' email, instant messages and/or the user's contacts 116. Voice mail content 124 may be tracked by using speech recognition 126 and text processing to identify any telephone numbers (and possibly names) left in a voice mail message. Web pages 114 that the user visited may contain the phone numbers that are of interest to the user. As described below, such numbers are managed automatically and intelligently, making it straightforward for the user to connect to any person or a business in which the user is interested.

FIG. 2 provides an alternative implementation in which the aggregation service is embodied as an example web service agent 202. Although not explicitly shown in FIG. 2, the agent 202 includes or is otherwise associated with harvesting and processing capabilities at least similar to those of the aggregation service 102 of FIG. 1. In this example, the data is primarily collected from sources coupled to the Internet. However, to exemplify various aspects as to how such an aggregation service may be implemented, FIG. 2 shows how a mobile service provider 222 may provide call information to the agent 202, instead of (or in addition to) requiring a user-performed synchronization operation with the computing device 212. Similarly, the voice mail 224 is shown as a service that is provided via the landline service at the PSTN 107, e.g., with recognition and number/name extraction 226 being performed by the landline service or the like, such as for incoming calls not accompanied by caller ID data.

Regardless of how implemented, in general, once the data is collected and processed (analyzed and organized), the aggregation service 102 essentially builds a personalized set of contact data or the like for the user. Note that the web service 202 may be shared by many users, with each user/user device identified in some unique way to the service, but in general operates in a similar way for each user. Further, note that the data collection and processing is typically ongoing and dynamic, e.g., as a user calls a new number and/or is called from that number more and more, that number, frequency and calling pattern are used to move that number up in likelihood that the user will be calling it again. Moreover, the aggregation service 102/web service agent 202 may look up related information from the data store or stores 104 as needed, such as for any new incoming or outgoing number, and occasionally (or possibly every time) for a known number to ensure that the related information for that known number is up-to-date.

The user may access the personalized smart call history 134 in any number of ways, including by web page lookup, by dialing a telephone number that provides access, and so forth. The dashed lines in FIG. 1 to and from the smart call history 134 represent any suitable interface to access the data. In one example, the user can access the collected and processed data via speech from one of the user telephones, which is then recognized via a speech recognizer and command processor 144 to take a requested action. Because the speech recognition can access personalized data for that user to find a requested person/business/business category (e.g., “call the plumber”) or the like, the recognition is highly accurate and provides a significantly improved user experience.

The aggregated numbers may be organized in various ways, including based on the behavior usage. For example, the more a user calls a number, the higher the probability the user will be seeking to call that number again. A user may intervene if there is a correction needed, or to manually enter contact information.

In one example implementation, the analyzer uses a time-based weight that decays over time, whereby the most recent changes have a higher probability in the event the usage probability is identical (or within a certain acceptable threshold difference). In another example, the probability of manually entered items is generally higher than that of the automatically harvested items. Any number of factors may be considered and the data weighting tuned over time, such as how often a number calls in to the user, how long it has been since the user last communicated with a number, and what the typical interval is. Other factors such as the time of day, day of week, time of year and so forth may be used. In one example, the combination of different sources is done probabilistically in a framework, such as in a Bayes decision framework.

For a visible representation of the call history, the user may request one of a variety of views, such as a usage-based view (e.g., frequency or time) or alphabetic view on the contacts. There is also an option for the user to view automatically harvested numbers separately from any manually created contacts. Any sorting, filtering, grouping and so forth of the data to provide a view may be available in a given implementation.

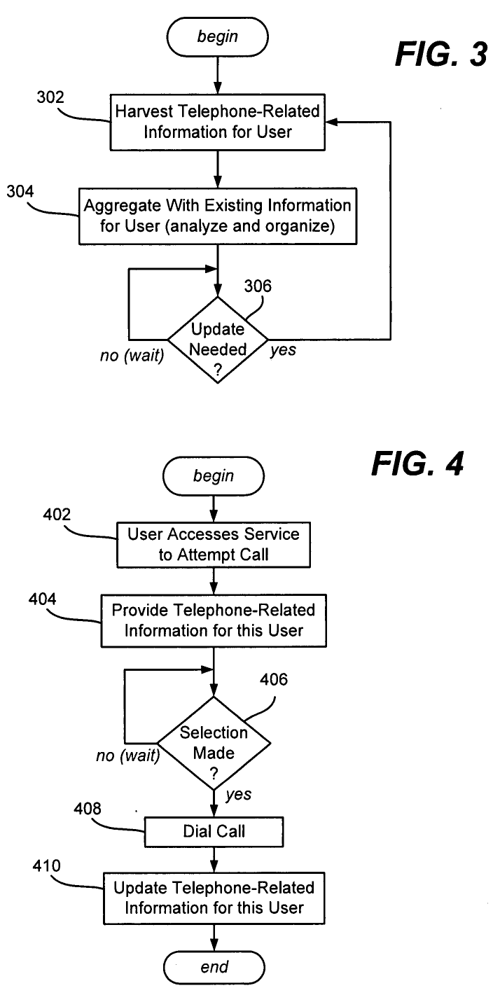

FIG. 3 is a flow diagram generally summarizing the aggregation operations. In general, as represented in FIG. 3, the aggregation service harvests telephone-related information for a given user from the various sources mapped to that user and other resources, such as an online information data store. Note that harvesting need not be from all sources all of the time, e.g., only a subset of information may be harvested, such as on demand whenever a user makes or receives a telephone call and the aggregation service becomes aware of it, and by occasionally polling other sources for changes.

Step 304 represents aggregating the harvested data with existing information for this user. In this manner, a personal database of telephone-related information is built and updated for this user. As represented in FIG. 3, the aggregation includes any processing such as analysis and organizing into some structure, but as can be readily appreciated, some or all of the processing can be performed by another process, including one which reduces or even eliminates some information, such as based on age.

Step 306 represents an update being needed, such as by time, an event such as a synchronization, an incoming or outgoing call being detected, and so forth. In this example, harvesting (whether full or selective) and aggregating (whether immediately after harvesting or deferred) are repeated as a need for updates is triggered.

FIG. 4, step 402 represents a user contacting the service to request a visual list of that user's telephone-related information for purposes of making a call. Note that it is feasible to access the service for other reasons, such as maintaining the user's database, but in most situations the purpose of requesting a visual list will be to attempt a call. Step 404 represents providing the aggregated telephone-related information to the user, and also implicitly includes any possible sorting, grouping and/or filtering by default or as specified by the user, including any re-requests for a different view. Note that some security measures such as requiring credentials may be employed before providing a view of a user's aggregated telephone-related information, which may further enable a user to use another person's telephone to access the service.

Step 406 represents waiting for a user selection of a contact. When made, (assuming not canceled in some other manner), step 408 dials the call using the number corresponding to the contact that was selected. Step 410 represents updating the user's telephone-related information for this call, including the contact/number dialed, any pattern and/or other information relevant to the call, e.g., which telephone device was used to access the service, whether the call was answered, busy, went to voicemail, a date-and-timestamp, the length of the call, number of rings to answer and/or any other information that may help weight this contact/telephone number relative to others in the user's telephone-related information.

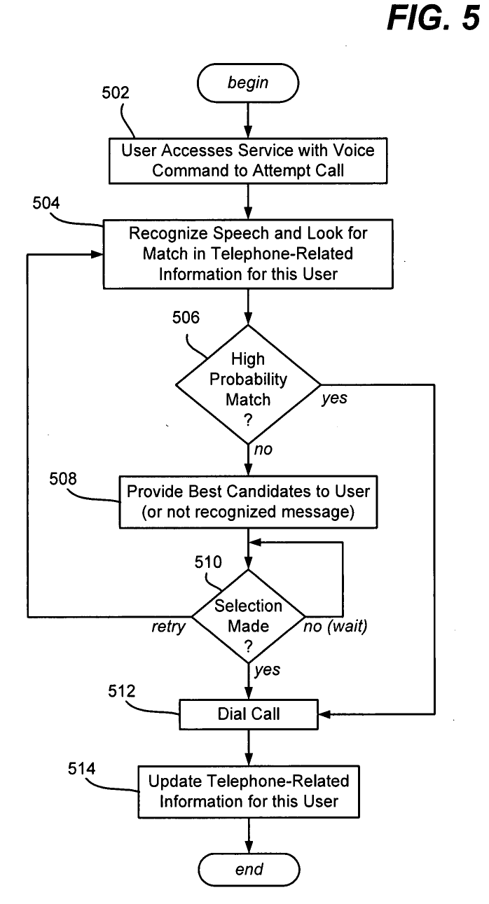

FIG. 5 represents a request made by voice to dial a user, beginning at step 502 which represents receiving the request at the service from a given user. Step 504 recognizes the speech input (which may include determining or validating the user identity via voiceprint) and looking for a match within the user's aggregated telephone-related information based on a contact (a personal name, nickname or title, business name, business category and so forth) recognized from the speech data.

Step 506 evaluates whether a match that is found has a high enough probability given various weighting factors (such as calling frequency and pattern, uniqueness of name, user preference data and so forth) to be deemed correctly disambiguated from any other possible candidates. If so, step 506 branches to step 512 to dial the call.

If further disambiguation is needed, step 506 branches to step 508 to obtain user input to assist in determining which of more than one candidate the user intended. Alternatively, step 508 may provide a message such as “please re-speak, recognition was not successful” or another similar prompt. Step 510 waits until it returns to step 504 on a retry, or branches to step 512 to dial the call upon selection of a recognized name being made. Step 514 updates the user's telephone related information, e.g., as generally described above with reference to step 410 of FIG. 4.

In this manner, a user's telephone-related information including call histories and telephone contact information from multiple sources are harvested automatically and processed to assist a user in placing a call. Different sources of such information may be widely varied, and may include call histories on different phones, the phone number contained in a user's redial, voice mail, messages, contact data, web page data and so forth.

The telephone-related information may be used to obtain probabilities (e.g., maintained probabilistically in a Bayes decision framework) that are then associated with a user's request to make a telephone call, and help determine an intended recipient's number and thereby provide an improved user experience. In addition to finding an intended recipient's number, maintaining aggregated telephone-related information for a user leads to applications such as voice or other automatic-dialing, call forwarding, call screening, and so forth. The probability data helps in user disambiguation (e.g., via a voice and/or visual user interface), to determine one most probable match or a subset of candidate matches.

### Exemplary Operating Environment

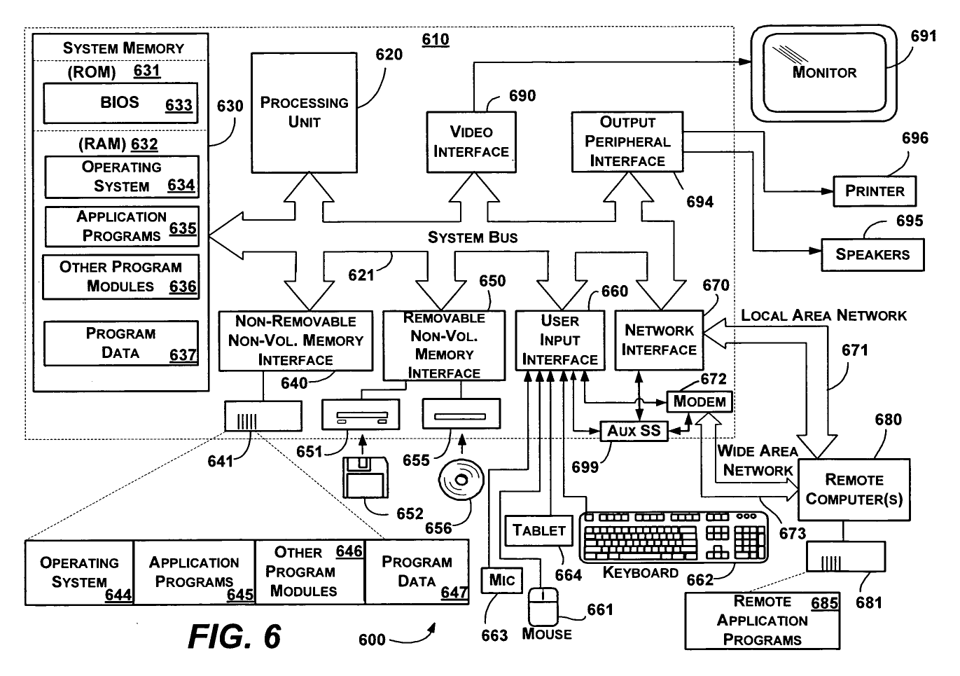

FIG. 6 illustrates an example of a suitable computing system environment 600 on which the computing device 112 and/or the service 102 or 202 of FIGS. 1 or 2 may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component 674 such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are exemplary and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a telephony environment, a method comprising:
aggregating telephone-related data for a user from a plurality of sources, including at least two telephones having different numbers that are associated with the user; and
using the telephone-related data to assist the user with a subsequent telephone operation.

2. The method of claim 1 wherein aggregating the telephone-related data comprises combining call history data corresponding to a landline telephone number and a mobile telephone number.

3. The method of claim 1 wherein aggregating telephone-related data for a user from a plurality of sources comprises accessing a database of information related to a telephone number.

4. The method of claim 1 wherein the user's subsequent telephone operation is making an outgoing call, and further comprising, processing the telephone-related data based on frequency and call pattern data to establish at least one telephone number that the user is likely trying to connect to in the outgoing call.

5. The method of claim 1 wherein using the telephone-related data to assist the user with a subsequent telephone operation comprises providing a visible list to a device of the user, and further comprising, receiving selection data corresponding to a selection from the list made by the user, and dialing a telephone number on behalf of the user based on the selection data.

6. The method of claim 1 wherein using the telephone-related data to assist the user with a subsequent telephone operation comprises recognizing user speech, matching at least one telephone number based on the recognized speech and probability data corresponding to each telephone number, and dialing a telephone number on behalf of the user.

7. The method of claim 6 wherein matching at least one telephone number based on the recognized speech comprises matching a plurality of telephone numbers, returning information to the user indicative of a need to disambiguate between possible selections, each selection corresponding to one of the telephone numbers, receiving selection data corresponding to a selection from the user, and wherein dialing the telephone number on behalf of the user comprises using the selection data to establish that number.

8. In a telephony environment, a system comprising:
an aggregation service that collects telephone-related data corresponding to a user;
a call history for the user built at least in part by the aggregation service from the collected telephone related data; and
an interface set containing at least one interface by which the user accesses the call history to assist in making a telephone call.

9. The system of claim 8 wherein the aggregation service collects the telephone-related data from at least one item or any combination of two or more items in a set, the set including, a telephone gateway, a mobile telephone, a landline telephone service, a mobile telephone service, an enterprise telephone system or server, a computing device, voice mail data, web page data, electronic message content, instant message content, a contacts list, or an information data store.

10. The system of claim 8 wherein the interface set includes means for coupling a telephone device to a speech recognizer that is coupled to access the call history for the user based upon one or more spoken requests.

11. The system of claim 8 wherein the interface set includes means for returning information corresponding to at least part of the call history for viewing by the user.

12. The system of claim 8 further comprising means for processing the call history data to determine a user's intent with respect to assisting in making the telephone call based on probability.

13. One or more computer-readable media having computer-executable instructions, which when executed perform steps, comprising:
harvesting telephone-related data from a plurality of sources, including sources corresponding to a user;
maintaining the telephone-related data in association with the user;
receiving a communication from the user with respect to placing a telephone call to a recipient identified by data that does not include the recipient's telephone number;
and accessing the telephone-related data for the user to assist the user in making the telephone call.

14. The one or more computer-readable media of claim 13 wherein receiving the communication from the user comprises receiving voice input, and wherein accessing the telephone-related data comprises searching for matching data based on the voice input that corresponds to at least one recipient.

15. The one or more computer-readable media of claim 14 wherein a plurality of candidate recipients are matched based on probability data, and further comprising, communicating with the user to determine which of the plurality of candidate recipients was intended by the user.

16. The one or more computer-readable media of claim 14 wherein one recipient is matched based on probability data, and having further computer-executable instructions comprising, automatically dialing a telephone number corresponding to that one recipient to assist the user in making the telephone call.

17. The one or more computer-readable media of claim 13 wherein harvesting telephone-related data comprises obtaining the telephone-related data from at least one item or any combination of two or more items in a set, the set including, a telephone gateway, a mobile telephone, a landline telephone service, a mobile telephone service, an enterprise telephone system or server, a computing device, voice mail data, web page data, electronic message content, instant message content, a contacts list, or an information data store.

18. The one or more computer-readable media of claim 13 wherein receiving the communication from the user comprises receiving a request for a selection set, and wherein accessing the telephone-related data comprises returning at least part of the telephone-related data to the user as the selection set.

19. The one or more computer-readable media of claim 18 having further computer-executable instructions comprising, receiving a selection from the user based on a selection of the selection set, and automatically dialing a telephone number corresponding to that one selection to assist the user in making the telephone call.

20. The one or more computer-readable media of claim 19 having further computer-executable instructions comprising, updating the telephone-related data for the user based on the communication from the user with respect to placing the telephone call.
